(19) United States
(12) Patent Application Publication
(10) Pub. No.: US 2010/0019924 A1
(43) Pub. Date: Jan. 28, 2010

(54) POSITION FINDING SYSTEM FOR PEOPLE, ANIMALS AND OBJECTS

(75) Inventors: Leonardo D'Alessandro, Conversano (IT); Antonio Sacchetti, Conversano (IT); Giovanni D'Argento, Conversano (IT)

Correspondence Address: YOUNG & THOMPSON, 209 Madison Street, Suite 500, Alexandria, VA, 22314, US

(73) Assignee: MATRIX SRL, Conversano (BA) (IT)

(21) Appl. No.: 11/722,379

(22) PCT Filed: Dec. 23, 2005
(86) PCT No.: PCT/IT2005/000762

§ 371 Date: Jun. 21, 2007

(30) Foreign Application Priority Data
Dec. 23, 2004 (IT) BA2004A000059

(51) Int. Cl. G08B 5/22

(52) U.S. Cl. 340/825.36

(57) ABSTRACT

Innovatory electronic system for the position finding of people, animals, and things. It includes a plurality of transceivers and a transmitter, both provided with hardware and software with low power consumption. Transceivers can be interfaced with one another both directly and indirectly on a network, thus providing an “autoforming network”, that creates and expands automatically, which increases the position finding distance of each transceiver so that a generic transceiver interconnected on a network can carry out a specific position finding of the location of a transmitter carried by the thing to be found.

The present invention relates to an innovatory electronic system for the position finding of people, animals, and things.

The demand for monitoring the movements of children, elderly people, handicapped, pets, means of transport, etc. in order to guarantee their security is still growing up. Furthermore, the increasing in the number of crimes, generally and specifically those towards children, involves a greater demand of concrete preventive measures to the market. The growing demand of the market for such type of products is, for example, proved by that great Companies of management of thematic parks, such as the Company managing the vast park “Legoland” at Billund in Denmark, have been using systems allowing the path of each child inside the area of the park to be traced for the last years with the aim at increasing the number of visitors and inducing the parents to remove the fear of missing their children within a vast, crowded area.

The present systems used for finding people, animals and things can mainly be divided into three great families, “GSM”, “GPS+GSM” and wireless systems, as a function of the applied technology.

The position finding process of the first family (“GSM” telephone system) allows the approximate distance of a “GSM” terminal from the base radio station to which it is connected to be detected. By repeating sequentially the calculation of the distance from several surrounding cells (BTS) and carrying out some operations of trigonometric triangulation, it is possible to take the approximate bearing of the location of a mobile phone over the area. By this method the bearing of the location of a “GSM” terminal could be taken by using the already available information of the “GSM” network, without controlling in any way the mobile phones. However, such a service is not still available on the market but can only be used by telephone service providers and police. In this case the position finding is called “cell-based” position finding, i.e. based upon the position finding of the cell “lodging” the mobile phone time by time. The precision by which the position finding of the location of a “GSM” phone can be carried out depends then on the characteristics of the cell and the transmission conditions of the mobile phone. To this end, four different position finding modalities by “GSM” systems are possible today: omnidirectional cell; omnidirectional cell associated with time advance; sector cell; and sector cell associated with time advance.

The omnidirectional cell is formed by antennas radiating to all directions and allows the location of a terminal to be detected with a maximum precision equal to the radius of the cell, i.e. it can be only stated that the terminal is within the covering area of the cell.

The omnidirectional cell associated with time advance allows the position finding precision to be increased as the network induces the mobile phone to perform a connection and calculates the distance between terminal and antenna on the basis of the transmission delay time, thus reducing the position finding area from a circle to a circular crown. The terminal is then spotted inside a crown but the angular position of the same is still unknown.

By the sector cell (most frequent case) the station radiates towards several sectors, thus allowing the terminal to be spotted with the maximum precision of the sector covered by the cell even if, however, the distance from the antenna is unknown.

The sector cell associated with time advance allows the area position finding precision to be increased, such area being reduced from a circular sector to a circular crown sector but also in this case its angular position remains unknown.

To increase the precision of the measurement one can resort to several BTS (more cells) and then calculate the location of the mobile phone by a triangulation. The operation is more complex but allows more precise results to be obtained.

Although the technology of the state of art is able to take the bearing of the location of a “GSM” mobile phone, a bearing service available to all users is still not active today.

The “GPS” (Global Positioning System) is the most known and diffused position finding system. It is based upon the principle of reception of radio signals from artificial satellites which are processed on earth by measurement apparatus to find the location of a person, animal, or object. Such system is based upon trigonometric calculations and iterations having as fixed reference point the propagation speed of the electromagnetic waves, each “GPS” transceiver being able to receive simultaneously the radio signals from a plurality of satellites and to calculate the distance from the latter on the basis of the received different information. Actually, any type of “GPS” apparatus is a receiver only, therefore it is not able to transmit any information.

To make information available that “GPS” is able to generate as well as to extend the possibilities of its use, the “GPS” system has been then integrated with the “GSM” system because a “GSM” mobile radio system coupled to a satellite receiver allows the coordinates of the detected position to be sent to the user. The “GPS+GSM” system is most used to send data generated by a “GPS” by using the cellular telephone system in real time, although such system as well as the satellite antitheft device is still very expensive today.

Wireless systems generally are used for the communication, monitoring and service of control systems in which the signals propagate like waves through the space and not through wires or transmission cables. In a wireless system the transmission is mainly carried out via radiofrequency (RF) or via infrared (IR). The wireless position finding systems, in the simplest form of identification systems, consist of cards provided with microchips for logic and radio communication functions via antenna, the so-called transponder, and a radiofrequency reading device that receives and decodes the information contained therein. The information red is then transmitted on a net and processed. The range of such wireless identification systems (RFID) is presently very low (some metres). Another little advantageous reason of said systems is the presence of different standards. This has prevented such systems from being widely spread as effective position finding systems.

Wireless technology based upon the transmission of radio waves emitted by a transmitter (that can be put inside a bracelet, watch, etc.) allows the waves to be picked up by a plurality of receivers. Also in this case the detection of the distance from the transmitter to the receiver can mainly be carried out by two different modes, i.e. the measurement of both the radio signal power and the time taken by the same radio signal to reach the receiver. The most precise definition of the position occupied by the transmitter is instead obtained by a triangulation. Position finding systems of this type are, for example, those using “Wi-Fi” technology or those used by Beghelli and Quik Trak; even if there are many companies that operate in the production of position finding systems, only the above-mentioned companies are disclosed thereafter showing up their limitations and drawbacks as they are more representative of the wireless technology applied to the lookout for people, animals, and things. The “Wi-Fi” (“Wireless Fidelity”) system is a technology that allows data to be exchanged at high rate (11 to 54 Mbit per second) without using any net cable, but keeping a complete freedom of movement. “Wi-Fi” transmits via radio usually at the frequency of 2.45 GHz and is based on IEEE 802.11 standard (Institute of Electrical and Electronics Engineers) allowing fast wireless connections to Internet. It is enough to install the wireless card into the computer, to look for an antenna radiating the signal (hotspot) and to start wide band navigation.

The wireless card is able to transfer data between personal computers by using a signal based on high-frequency radio waves. The communication is ensured by the use of suitable devices interfaced with PCs able to transmit and receive radio signals. Just this capability of transmitting a signal is at the base of a position finding system with “Wi-Fi” technology.

The minimum configuration requires only two computers, both provided with a “Wi-Fi” card and located within a range of one hundred metres to create a wireless net.

By connecting a “Wi-Fi” access point to the router, any computer provided with a “Wi-Fi” card in the range of one hundred metres holds a dialogue not only with all other PCs but can also have free access to Internet.

By using this technology it is possible to provide position finding systems which, however, have considerable limitations as better explained thereafter.

The position finding system so-called “Safe Child” of Beghelli consists of a receiving base unit under the control of an adult which emits an acoustic signal as the child provided with a transmitting bracelet moves away beyond a predetermined distance which can be regulated according to three different values. Actually, such position finding system is not based on a net but is limited to an exchange of information between only two units. To calculate the distance between transmitter and receiver the device “Safe Child” calculates the power of the received signal which is a function of the distance but only in case of lack of obstacles between the same transmitter and receiver.

“QUIK TRAK” system, that has found application in some countries of the world but not in Italy, allows vehicles and sometimes people to be spotted by means of a transceiver that sends radio signals to receivers (fixed stations) distributed over the territory. The position finding is carried out by the measurement of the time taken by the signal to reach the different fixed stations. To define with enough precision the path followed by the vehicle upon its moving it is necessary that all receivers are perfectly synchronised with one another in order to provide only one measurement of time. To this end, each receiver is equipped with a “GPS” module provided with a sufficiently precise time counter or timing.

The drawbacks of the technologies of the state of art will be disclosed and shown up thereafter.

The first great limitation of the systems based upon “GPS” is given by the impossibility of operation in closed rooms. Actually, it is indispensable that the satellite receiver is at sight simultaneously from at least four satellites of the orbiting fleet. However, such a system has operating difficulties also in open air just because of an overcast sky. To this end, new so-called “predictive” systems able to operate also in closed rooms are being experimented. Such systems, however, are extremely complex and based upon a probabilistic calculation of the position which is moreover very expensive.

In addition, the “GPS” system was not created for commercial but wartime purposes, therefore, there is not any warranty of a service regularity. The European satellite system Galileo should solve this problem by ensuring also a considerable precision but presently it is not fully usable.

Another drawback of “GPS” systems is the location of a person or an object on which a satellite receiver is installed. Such a location is carried out by the calculation of the coordinates of a point on the basis of an estimation of the response time of the signal transmitted by the satellites. The processing, in fact, is carried out by the same receiver but it is essential that such receiver is coupled to a “GSM” module which sends the information regarding the above location in the form of coordinates for the latter to be made known to third parties. Of course, besides a more complex and expensive hardware of the system, a “GSM” module has also the drawback of high operating cost connected to the exchange of information.

A further drawback of the “GPS+GSM” systems is usually given by the size of the apparatus and even if receivers with the size of a watch have been manufactured by means of recent technologies, the necessary miniaturization of the antenna involves generally reception problems especially if it is not correctly oriented or partially “shaded” (it is sufficient a metal table to prevent it from operating!).

Another drawback is due to the fact that both “GPS” systems and “GSM” systems do not use the low-power technology with the consequence that the operating range of a portable apparatus of this type amounts to some days as a maximum provided that it is fed by its own cells. This is not a particular problem if the system is used for the position finding of vehicles provided with their own cells (or able to be fed by their own recharging system) but it is self-evident that such a system has a great limitation to the location of children and animals as it requires a continuous engagement to recharge the cells, which could be felt by the user as excessively bothersome or, in any case, not of immediate utility. The missing use of low-power systems in both “GSM” and “GPS+GSM” systems produces the further drawback that they are not adapted for the position finding of subjects that are particularly sensitive to the effects of the electromagnetic radiations on the health. On the other hand, nobody would conceive to place a transmitting apparatus with a power of about 1 Watt in contact with the body of a child continuously in time.

Another not less important drawback is the economic aspect. Even if “GPS” apparatus are even more spread, they still have a high cost and are then not particularly adapted to those applications which could bring to the loss or the damage of the apparatus.

“GPS+GSM” and “GSM” position finding systems have the further drawback of high power consumption that prevent them from being used in comfortable and is durable manner with autonomy of operation as far as a particular type of users such as children, animals, and objects without power supply is concerned.

Other already existing low-consumption systems of the wireless family have no optimum precision characteristics regarding the position finding as well as a very low covering range. Conversely, “GPS+GSM” and “GSM” position finding systems with a higher reliability and a larger range are very expensive still today and then little usable for the mentioned applications.

The drawbacks of “GSM” systems of the state of art, furthermore, are inherent in that those systems do not allow the service to be available to everybody still today, even if they locate the position of people and objects.

In particular, a position finding service directed essentially to the spotting of people only, for example, was supplied by Yahoo for a short time by using a technology made available by Cellpoint but some problems connected to the privacy brought to the interruption of the service.

Another more recent application is Teddyphone, a cellular phone provided with a few buttons for use of children and having the drawbacks of the technique based on GSM (such as for example the poor position finding precision), wherein it proposes to reduce the risks for the health of the children with the result of a detriment of the quality of the service because of the reduction of the signal covering area as a consequence of a signal power reduction.

Therefore, the “GSM” position finding service is at the moment a service that has some difficulty in being spread by the same telephone service providers and police.

A further drawback is given by the incompatibility often existing between the various “GSM” position finding technologies as well as the limited possibility of promoting the use for information service and commercial applications of the electronics independent of the type of mobile phone of the user.

Furthermore, likewise to what emphasized for the “GPS” apparatus, the “GSM” apparatus have the same drawbacks connected to size, cost and charge autonomy of the mobile phones.

The drawbacks connected to the technology of the existing wireless systems of the “Wi-Fi” type are correlated with the need of using computers provided with cards for the wireless connection which have overall dimensions, weights, and costs not acceptable for a device which has to be applied to a child, an object or an animal as well as high power consumption because of the need of a frequent cell recharging.

The drawbacks of the existing wireless position finding systems for the spotting of people are well exemplified by the system “Safe Child” produced by Beghelli which does not allow in any way information about the position of the child to be received beyond a limited range and a determined covering area.

Furthermore, such system has not been conceived for the position finding of animals and objects too because it would need frequent recharges of the cells of the transmitter which could not easily be used in case of animals. Many suitable position finding systems such as those proposed by Beghelli offer restricted, limited applications today.

Furthermore, the drawbacks of the existing wireless systems such as for example “Quik Trak” system are caused both by the missing application of the latter for the position finding of children and animals and the need of frequencies which cannot be used in many countries of the world and, additionally, it is based upon complex, expensive technologies requiring the use of “GPS” for the fixed stations which need a frequent, expensive maintenance because of the high power consumption.

The main object of the present invention is to fully overcome the limitations and the drawbacks of the previously disclosed systems by providing an innovative system for the position finding of people, particularly children, animal, and things by a new network of wireless transceivers and transmitters with low power consumption.

A further object of the present invention is at the same time to provide a reliable product of simple, practical use and above all low cost at the reach of everybody, even if it is based upon the wireless technology and creates suitable combinations of known technologies (such as for example GPS, GSM/UMTS, UMTS, RFID).

These objects are accomplished by providing a system 1 for the position finding of people, animals and things 2 which is particularly useful for a precise, instantaneous position finding of the location of people, animals, and things 2 in closed rooms and/or open air as described in the first and following claims enclosed therewith.

These purposes and the consequent advantages as well as the features of the method according to the present invention will be more readily apparent from the following description of some embodiments disclosed thereafter only by way of a not limiting example particularly with reference to the accompanying drawings, in which:

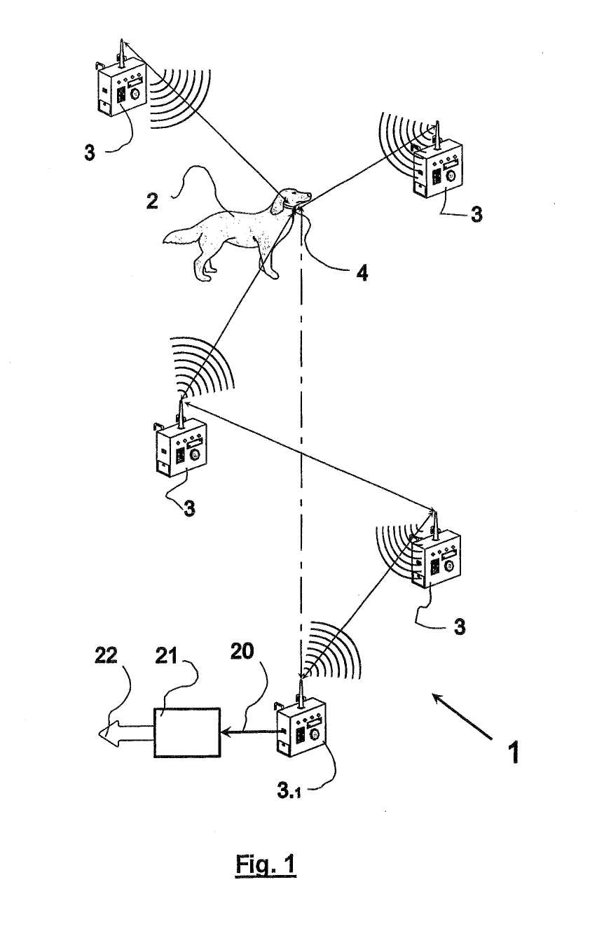

FIG. 1 is an exemplary schematic view of system 1 for the position finding of people, animals, and things 2 of the present invention showing a plurality of transceivers 3, by one 3.1 of which transmitter 4 applied to dog 2 is being located by the interaction via radio with transceivers 3 intercepting directly the signal of transmitter 4;

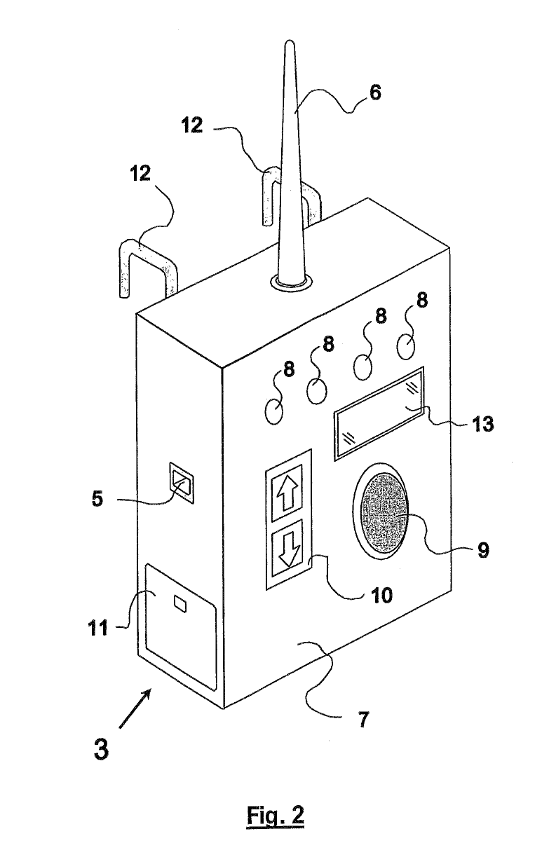

FIG. 2 is a three-dimensional schematic view of a preferred embodiment of transceiver 3 showing its main components;

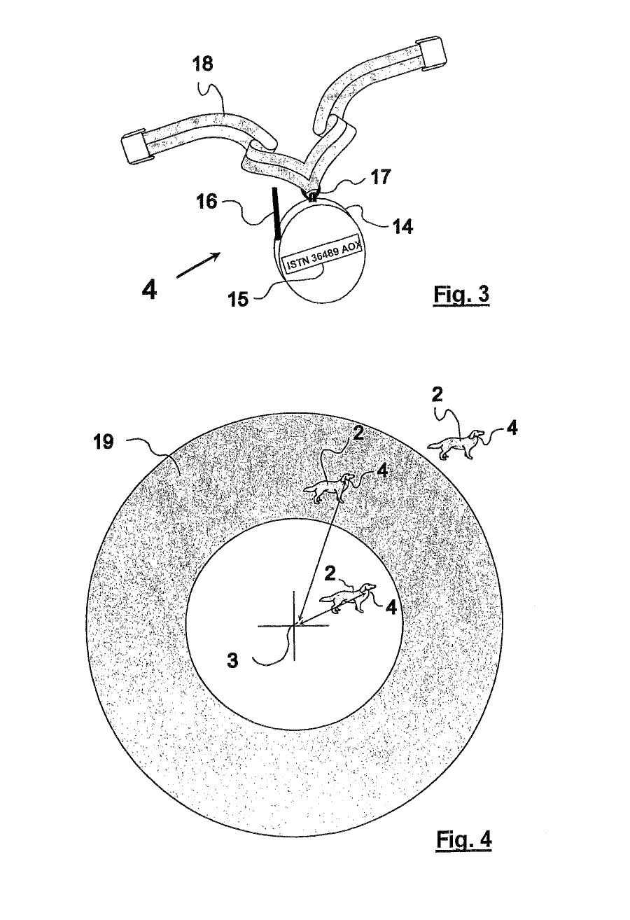

FIG. 3 is a three-dimensional schematic view of a preferred embodiment in which transmitter 4 is applied to dog 2 of FIG. 1 like a medal provided with belt 18;

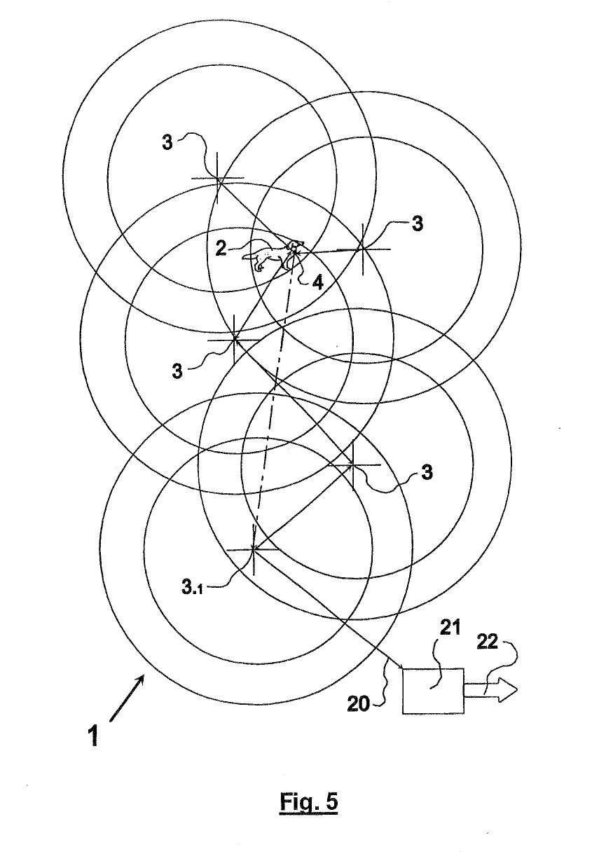

FIG. 4 shows a schematic view of the operation of a traditional system for the position finding of people, animals, and things 2 consisting of only one transceiver 3 having a limited transceiving range of the interception signal of transmitter 4 applied to dog 2 in the example shown, with a maximum value varying within a wide area 19 inside which the location is uncertain and beyond which dog 2 is not interceptable any longer;

FIG. 5 shows a schematic view of the operation of the innovative system for the position finding of people, animals, and things 2 depicted in FIG. 1 and consisting of a plurality of transceivers 3 which, even if their transceiving range of the interception signal of transmitter 4 is limited, allow the signal of transmitter 4 carried by dog 2 to be intercepted through connection on a net by processing the signals received from transceiver 3 even if transmitter 4 is far outside the range of interception of transceiver 3.1 looking for it.

With reference to the annexed figures it is evident that position finding system 1 shown thereby relates to a simple, cheap, effective application of position finding system 1 such as to be used in those environments where the application of “GPS”, “GPS+GSM” and “Wi-Fi” systems is totally or partly unsuited or insufficient because of complexity, cost and autonomy of operation or where the existing technology is not able to provide a qualitatively high service, for example, to make information available also via network as it is the case for the system “Safe Child” of Beghelli.

The main feature of the present position finding system 1 as shown in FIGS. 1 and 5 is actually the possibility of exchanging information among the several transceivers 3 with open protocols to support a number of applications (home automation, remote reading, RFID, traffic data, etc.) by using suitable frequencies (bands of 400 MHz, 800 MHz, 2.4 GHz). Transceivers 3 as well as transmitter 4 are provided with hardware and software with low power consumption.

Furthermore, transceivers 3 communicate to one another both directly and indirectly via network, for example, by a connection to a predetermined address, thus establishing an “autoforming network”, i.e. a network which is created and extended automatically at each new installation of a transceiver 3 and is able to increase the position finding range of each single transceiver 3 so that a generic transceiver 3.1 interconnected via network can start the position finding of the location of the child, thing or animal 2 to be found out, even if the latter is located at a distance which is far greater than the nominal range of transceiver 3.1 as it is possible to set up a communication among a plurality of position finding systems.

By comparing the present position finding system 1 with the state of art shown schematically in FIG. 4 where transceiver 3 cannot receive the signal of transmitter 4 carried by subject 2 (child, animal, or thing) to be found out beyond a determined range of limited position finding area as well as cannot detect the exact coordinates of the position of subject 2 but only an approximate distance within a circular crown corresponding to the radius and the precision of interception, it is self-evident that the inventive concept is concerned with the expansion of the interception radius of the generic transceiver 3.1 which can be obtained by connecting it via network to such a plurality of transceivers 3 and by processing the information sent by transmitter 4 and collected by such a plurality of transceivers 3 operating like a bridge for the generic transceiver 3.1 connected via network. A further inventive concept is also concerned with the mode of setting up the network which is then “autoforming”, i.e. it is created and extended automatically upon each new installation of a transceiver 3 which can be purchased by both private users and companies which invest in the position finding services or in their installation. The network is created without the need of an expensive installation of suitable network facilities, and the transceivers operating as bridges are the same transceivers 3 that also provide individually the interception service in their own covering area and allow a network to be autoformed without the need for the design and/or installation thereof in advance. It is evident that the interception service will be the more reliable and expanded the more transceivers 3 will be installed for individual use.

The present system provides signal routing nets that are designed unlike the installation in a suitable way, i.e. the protocol used will have an automatic signal routing able to provide predetermined paths for a communication from a transceiver to another one specific for that suitable connection which is necessary because a new user (transmitter, but also transceiver) has joined the system.

The inventive concept of the position finding system disclosed is inherent in the information exchange among the several transceivers or base unit 3 which are able to operate as receivers and also as transmitter of information to other transceivers 3. Some transceivers 3, additionally, are also provided with a (fixed or mobile) telephone for the connection to Internet to supply the public telephone service with the information collected. Actually, just because of a dialogue among the several units, the connection of only one transceiver for each service area (cell structure) is enough.

The size of each such cell depends on the topographic, geographic configuration of the territory as well as the average traffic of data, the number of repetitions of information provided by the protocol, the average range of the signal, and the quality of the service ensured.

Thus, the several transceivers 3 are going to set up a network which is far wider with respect to the range of the single transceiver 3 and arranged to be expanded automatically at each new entry of a transceiver 3 by the users into the network.

In the preferred embodiment at least a pair of transceivers 3 is provided initially, both of them being able to exchange information with other base stations via air, and at least one of them being also provided with a socket 5 for PN/modem/LAN (PN stands for Public Network, or PSTN stands for Public Switched Telephonic Network or still PLMTN stands for Public Land Mobile Telephonic Network, i.e. telephonic or not, public networks such as Internet with circuit or packet switching; modem stands for an analogue or SDSL modem or other modems connected to a PN) for the connection to public network 22 as it is inferred from the preferred, not limiting embodiment with accessories shown in FIGS. 1 and 2. The embodiment shown in FIG. 2 is preferred but is not provided with the further components such as “GPS+GSM/UMTS”, “GSM/UMTS”, “BLUE-TOOTH” and infrared modules or other equivalent modules and accessories which it consists of. Transceivers 3 of the latter embodiment have to be necessarily installed at fixed points, for example balconies or terraces of single or condominial houses as well as provided with telephone sockets for the connection to Internet to allow all acquired information to be exchanged via network. To push purchases of the latter embodiment the network service providers usually propose credit facilities to anyone will decide to choose such type of transceiver 3 and to carry out the installation. Instead, the one who won't connect his/her own transceiver 3 to public network 22 can always purchase the standard embodiment without output 5 to public network/modem/LAN. Optionally and/or alternatively, a “GPS+GSM/UMTS” module or the like can be put into GPS transceiver 3 so that socket 5 for PN/modem/LAN as well as the fixed location of transceiver 3 is not necessary. Such insertion of GPS+GSM/UMTS module in the transceiver allows the position finding in case of not fixed relay station which is, for example, installed on board of a car or other vehicles, or generally where a transceiver 3 or a plurality of transmitters 4 can be installed.

The socket for PN/modem/LAN is arranged in models connected both directly to telephone system 22 and an outside modem 21 by means of a suitable connection cable 20, and also to a LAN. Should a transceiver 3 with internal modem be provided, a socket for data transmission to modem (for example a standard serial gate RS232) will be provided instead of the telephone socket. In case of connection to a LAN the connecting cable 20 will be of the suitable type.

The one who would like to use only the on-line position finding service for spotting the position of a child, animal or object 2 through the access to the net but he/she wasn't interested in the purchase of transceiver 3, he/she can receive an acoustic alarm through his/her cellular phone if the object or the child or the animal 2 to be found out should move away beyond a certain distance from a predetermined area already covered by other transceivers 3, thus making use in any way of the service even if at a different cost.

Transceiver 3 is provided with a case 7 which can be manufactured with a suitable protection degree (for example IP 54).

Transceiver 3 of a preferred embodiment shown in FIG. 2 is mainly provided with an antenna 6 preferably positioned outside case 7 of transceiver 3, a plurality of light emitting diodes or LED 8 with switch 10 for the calibration in the field, a warning horn 9, a battery room 11, and at least a fixed support means 12 of transceiver 3 for wall or balcony.

In a second preferred embodiment, as derived from FIG. 2, said transceiver 3 is also provided with a socket 5 for PN/modem/LAN for the connection of transceiver 3 via network, a socket for outside power supply, a keyboard 10 for regulating the acoustic signal intensity, the calibration in the field, and other optional functions, and a display 13 which is a further visual means or replaces said plurality of led 8. The power supply for the transceiver can be taken directly from the socket 5 for PN/modem/LAN.

A third preferred embodiment of the present system is characterized by a kit consisting of a transceiver 3.1 provided with integrated “GPS+GSM/UMTS” module for the solution of the specific problem of the position finding of groups of things/people/animals 2 (or more generally “objects” 2) that can move over geographically wide territories even if they always stay together in a group. In fact, in this case the transceiver is arranged for remote sending, automatically or on request, the information relative to the position as well as, which is more important, relative to how many objects 2 are present in the interception range through public network to a web site or through short message service (SMS) of cellular phones, with the possibility of setting up an alarm function in case of a missing signal from only one monitored object 2. This solution allows a remote position finding service to be set up, even if there is no repeater network in the territory, and is also effective without a GPS signal because it is, however, enough to know that the object 2 has moved away.

The latter application of the present position finding system can be useful to allow elderly people and children upon going on a trip or walking within an area to be spotted, as well as works of art transported from a museum to another for temporary or travelling art exhibitions to be found out, etc. Transceivers 3.1 have a known position as they are connected to the public network through socket 5 for PN/MODEM/LAN, but generally and when not connected to the public network, the information relative to their position is transmitted via radio or via cable upon installation and stored in memory. Therefore, said transceivers 3.1 are able to communicate their positions in association with an information relative to reliability of their positions. In fact, these positions could be derived from the GPS coordinates in case of transceiver 3.1 with internal GPS+GSM/UMTS option, or fixed by the operator upon fixed installation. In the latter case, transceiver 3 or 3.1 is able to operate by a firmware routine in case the information is little reliable because it:
checks whether the connection to public network is set up in case of connection to PN/MODEM/LAN;
compares the position detected by a transceiver 3 with the position detected by other transceivers 3 or 3.1 in case the former is not arranged for the connection to the public network. In case transceiver 3.1 is connected to the public network or provided with GPS module, transceiver 3.1 performs triangulations to spot first its own position with respect to the position of the other repeaters or transceivers 3 and 3.1 in communication therewith, the latter transceivers communicating in turn their own coordinates together with data about their reliability. Generally, the information about the reliability of their position depend also on the fact that transceivers 3 and 3.1 can further be provided with a position sensor.

As far as transceivers 3.1 provided with internal GPS+GSM/UMTS module is concerned, a fourth preferred embodiment equipped with portable container for installation, for example, on board of vehicles can also be proposed. In this case, the power supply is derived from the same vehicle: the battery of the vehicle is the back-up, and a connection cable or a bluetooth module or the like is connected directly to socket or connector 5 for PN/MODEM/LAN. The latter (cable and bluetooth module) allow the connection to:
an outside device for the collection of data from sensors-actuators of the vehicle;
GPS navigation system previously installed on board of the same vehicle.

In the latter case transceiver 3 will use a communication format which is compatible with GPS systems or the like (for example “NMEA” or the like) as it is the case in the communication of position data among transceivers or repeaters 3 and 3.1.

In any case the “autoforming” network” takes into consideration transceivers 3 and 3.1 in the same way as transmitters 4 and then takes the bearing of the parameters detected thereby. The protocol among repeaters 3 and 3.1 and transmitters 4 is able to communicate at a speed of 100 km/h such that also a travelling vehicle can be used as mobile transceiver to widen the range of interception of the network of transceivers 3.1. As the protocol is open, i.e. the fields of its frame can also be used for general applications, the repeaters or transceivers 3.1 are allowed to be used for data communication among vehicles. The communication protocol of transceivers 3 and 3.1 is such as to allow, in addition to remote reading of apparatus, home automation, and traffic data, also the reading of RFID transponder of new generation (worldwide standard “EPC” of second generation) in standards UHF and/or 2.4 GHz, or if enabled via firmware (for example in factory, upon installation or afterwards via radio) it can transmit beacons capable of operating the transponders existing in their range to allow them to be spotted and identified.

Transceiver 3 can be in the form of a OEM card that can be integrated within a common satellite navigator available on the market.

Transmitter 4 according to a preferred embodiment shown schematically in FIG. 3 consists of a shock-resistant case 14 with protection degree IP 54 having small size and provided with a serial number of identification 15 of the transmitter included therein as well as an antenna 16 preferably outside case 14 and of flexible type to keep size and weakness to a minimum.

Transmitters 4 or devices to be positioned on objects 2 to be found out could also be used as receivers having hardware and firmware similar to those of transceivers 3 and 3.1, in particular in other preferred applications as follows:
where it is desired to change the parameters of the transmitter, for example the transmission frequency of the signal;
where it is desired to exchange communications not only in position finding mode but also in identification mode compatible with the worldwide standards EPC of second generation, versions UHF and/or 2.4 GHz or still in beacon receiving mode if enabled via firmware.

As the protocol is open, i.e. the fields of its frame can also be used for general applications, transmitters 4 can optionally be provided also with internal sensors (for sensing atmospheric pressure, temperature, humidity, etc.) to allow data detected by the same sensors to be transmitted together with data of its identification and position.

Case 14 is also provided with hook means 17 for securing a belt, collar, necklace or any other means 18 to make transmitter 3 integral with child, animal or moving object 2 to be found out in time.

Position finding system 1 is also characterized by the high autonomy of operation of the batteries as they allow a minimum range of 3-4 years for the transmitter and 4-5 years for the transceiver so that the replacement of such batteries is occasional.

According to a preferred embodiment, “AAA” thionyl lithium chloride cells of 3.6 V for transmitter 4 and “C” cells for transceiver 3 are used.

The minimisation of the power consumption in the transceiving steps is ensured by an accurate selection of the components of the FW routine architecture, interval optimisation, signal transmission mode, and communication protocol. These higher levels of autonomy are an important result that cannot be compared with the average consumption of the “GSM/UMTS”, “GPS+GSM/UMTS” or “Wi-Fi” integrated systems of the state of art which require a by far more frequent recharge of the cells.

The minimisation of the transmitted power by transmitter 4 which has a peak of 25 thousandth Watt as a maximum and is lower than one thousandth Watt on average, has the advantage that transmitter 4 may be secured continuously to subjects particularly sensitive to electromagnetic pollution such as children, thus minimising the risks.

The disclosed position finding system 1 can easily be adapted to a number of applications owing to said open protocol compatible with the standard for the supply of further services (for example remote reading of meters, home automation, traffic data, etc.).

To widen the range of the services, position finding system 1 can in any case be coupled with “GPS+GSM/UMTS”, “GSM/UMTS”, “BLUETOOTH” and infrared modules or the like.

The invention is also characterized by a high quality, reliability, easiness of operation, high autonomy of operation, small size, low cost, ecological compatibility, and crossed exchange of information among the single units and the network.

A product including all these features concurrently is hard to design and actually there is no other position finding system characterized by the above-mentioned performance today.

The design of the preferred embodiments of the invention has required to cope with complex technical, scientific problems solved by a suitable selection of the individual SMD components on cards with small size and a suitable design of FW and particularly a communication protocol such as to fulfil the expected performance such as the signal transmission mode, range, data updating frequency and so on.

Position finding system 1 of the present invention makes use of low-power technology for the chips of transmitter 4 and transceivers 3 and is characterized by low cost because of the simplicity of the adopted technology, and the open protocol allows the range of the possible applications to be widened as well as GPS+GSM/UMTS”, “GSM/UMTS”, “BLUETOOTH” and infrared modules or the like to be coupled. Particularly if transmitter 4 and transceiver 3.1 use a GPS module in low-power mode coupled with an internal wireless SRD module, they can make use of their internal memory to store their positions and, in case of transceivers 3.1, the memory of other transmitters 4 in all time intervals in which they could not be previously spotted by transceivers 3, 3.1 so that said positions can be thereafter transmitted via radio. Said coupling has the advantage of receiving information also from not fixed transceivers 3.1 and transmitters 4, for example on board of vehicles.

The novel position finding system 1 achieves remarkable improvements and optimisations. Particularly it has the advantage of a very low likelihood of obsolescence as system 1 allows the individual components to be strengthened and replaced in time as well as further modules to be added for the product to be adapted to the future requirements (home automation, remote reading of counters, etc.) without the need of replacing transmitter 4.

It should be appreciated that the advantages of the present invention consist above all of having conceived a position finding system 1 which is flexible, scalable, of simple manufacturing, of easy technical feasibility, and with a minimized final cost.

A further advantage of position finding system 1 consists of the theoretically unlimited increase of the interception range of transmitters 4 because a controlling system able to transmit at any moment the position of the object to be found out with high precision is connected to the net.

Another advantage of the present invention is to have conceived a position finding system 1 having components with low power consumption, thus allowing a long range autonomy of operation of the batteries.

It is self-evident that a number of modifications, adaptations, integrations, variations and replacements of elements with other functionally equivalent elements can be made in the embodiment of the position finding system previously described by way of an illustrative, not limiting example without departing from the scope of the following claims.

1. A position finding system (1) for people, animals, and things, or objects (2), which is particularly useful for the precise, present position finding of said “objects” (2) in closed rooms and/or open air, consisting of a plurality of wireless or wireless SRD (Short Range Devices) transceivers (3, 3.1), characterized in that each object (2) to be spotted is provided with a transmitter (4) and in that both said transceivers (3, 3.1) and said transmitter (4) are provided with hardware including at least one microcomputer, a radio set, an internal reprogrammable memory, and a low-power control and communication software (protocols), said transceivers (3, 3.1) and said transmitter (4) communicating among one another both directly through wireless network and indirectly through the telephone service network to provide an autoforming network able to be generated and extended automatically upon a new installation of a transceiver (3, 3.1), said new installation expanding the spotting distance of each single transceiver (3, 3.1) so that a generic transceiver (3, 3.1) can carry out a precise, optimum finding of the location of transmitter (4) connected to each object (2) to be found out, even if the latter is located at a distance which is by far greater than the nominal range of transceiver (3, 3.1), both a remote multiple repetition of the signal containing the information of the position calculated by a measurement of power and/or delay of the signal and a processing of the information about the position of a transmitter (4) collected by said plurality of transceivers (3, 3.1) being also possible via network; wherein at least one of said transceivers (3, 3.1) has the information about its own position stored in memory.

2. Position finding system (1) according to claim 1, characterized in that said wireless SRD or simply wireless feature of transceivers (3, 3.1) is intended as the use of frequency, modulation, and power such as to allow the ratio among the distances of propagation of the transmitted signals and the power consumed to be optimised as well as the use by the greatest number of countries.

3. The position finding system (1) according to claim 1, characterized in that said low-power feature is intended as the use of hardware circuits and components with low power consumption and firmware/software routine that are strictly parameterised and reprogrammable by the user or the service provider of system (1), thus allowing said components and circuits to be operated only for the strictly needed time for the execution of the functions required by the system or the user.

4. The position finding system (1) according to claim 1, characterized in that said transceiver (3) is provided with a case (7) manufactured with a suitable protection degree, an antenna (6) preferably positioned outside the case (7) of transceiver (3), a plurality of photodiodes or led (8) with a switch or buttons (10) for the calibration in the field, an electroacoustic transducer (9), a battery space (11) and at least a fixed support means (12) of transceiver (3) to be installed on the wall or in a balcony.

5. The position finding system (1) according to the preceding claims, characterized in that said transceiver (3) has the information about its position stored in memory if it is operating in an autoforming network, said information being transferred via radio or via cable upon installation.

6. The position finding system (1) according to claim 1, characterized in that said transceiver (3.1) is further provided with a socket (5) for PN/modem/LAN for its connection on a network, a socket for external power supply, a keyboard in replacement of buttons (10) to regulate the acoustic intensity of the signal, the calibration in the field and other optional function, as well as a display (13) in replacement of said plurality of led (8) or as further visual support.

7. The position finding system (1) according to claim 1, characterized in that said external power supply of the transceiver is derived directly from the socket (5) for PN/modem/LAN.

8. The position finding system (1) according to claim 1 +GSM/UMTS integrated module which is useful in case the connection to PN/modem/LAN is missing and particularly useful for the solution of the specific problem of position finding of groups of objects (2) that can move over geographically very wide territories, still remaining in the group.

9. The position finding system (1) according to claim 1, characterized in that said transceiver (3.1) is arranged for the remote transmission of the information relative to its position as well as, which is more important, relative to how many objects (2) are present in its range of interception automatically or on request through public network to a web site or through a short message service of the cellular telephony, with the possibility of setting up an alarm function in case of signal loss from only one monitored object (2) so that a remote position finding service is provided even if a network of territorial repeaters is missing and is also able to operate without GPS signal, however being enough the information that an object (2) is moving away.

10. The position finding system (1) according to claim 1, characterized in that said transceiver (3.1) holds an information relative to its position in its memory, said information being transferred via radio or cable upon any installation, said transceiver (3.1) being able to communicate, in addition to its position, also an information relative to the reliability of said position when said transceiver further provided with a position sensor has been previously disconnected from the public network by detaching the socket (5) for PN/MODEM/LAN and/or displaced from its initial position.

11. The position finding system (1) according to claim 1, characterized in that transceiver (3, 3.1) is able to communicate the reliability of the transmitted information relative to its position by a firmware routine and compares its position preset upon installation with the position detected by other transceivers (3 or 3.1).

12. The position finding system (1) according to claim 1, characterized in that said transceiver (3.1) is provided with a case (7) with reduced size in the same way as a cellular phone such as to be easily portable.

13. The position finding system (1) according to claim 12, characterized in that said transceiver (3.1) provided with portable case (7) can be installed inside vehicles, the internal battery (11) of said vehicles being also used as back-up power supply.

14. The position finding system (1) according to claim 13, characterized in that said transceiver (3.1) is optionally provided with a bluetooth module or the like inserted inside or placed outside transceiver (3.1) and connected to socket (5) of the latter.

15. The position finding system (1) according to claim 14, characterized in that said bluetooth module serves to the connection to an external device collecting data from the sensor-actuators of the vehicle and GPS navigation system of the same which receives the position of a transmitter (4) found out by the wireless net of transceiver (3, 3.1) from transceiver (3.1) by using a data format of its protocol which is compatible with GPS systems or the like (for example “NMEA” or the like) relative to the data of position.

16. The position finding system (1) according to claim 13, characterized in that said transceiver (3.1) is optionally provided with a communication cable to be connected directly to socket (5) for the connection of an external device having the function of collecting data from the sensors-actuators of the vehicle as well as of the GPS navigation system of the same vehicle which receives the position of a transmitter (4) found out by the wireless net of transceiver (3, 3.1) from transceiver (3.1) by using a communication format of its protocol which is compatible with GPS systems or the like (for example “NMEA” or the like) relative to the data of position.

17. The position finding system (1) according to claim 1, characterized in that said autoforming network takes into consideration transceivers (3, 3.1) in the same way as transmitters (4) and then locates them and detect their parameters.

18. The position finding system (1) according to claim 1, characterized in that said communication software or protocols among repeaters (3 and 3.1) and transmitters (4) communicate at relative speed over 100 km/h so that also a moving vehicle can be used as mobile support for a transceiver to expand the range of interception of the net of transceiver (3, 3.1).

19. The position finding system (1) according to claim 1, characterized in that said protocol is open, i.e. the fields of the frame can be used for general applications and is also able to perform the communication with apparatus for remote reading, home automation, detection of traffic data, RFID transponder of new generation (worldwide EPC standard of second generation) in UHF and/or 2.4 GHz versions, or, if enabled via firmware in factory, upon installation or thereafter via radio, the transmission of beacons capable of operating the transponder existing in the range to allow spotting and identification.

20. The position finding system (1) according to claim 1, characterized in that said transceiver (3, 3.1) can be manufactured in the form and size of an OEM card able to be integrated within a satellite navigator already available on the market.

21. The position finding system (1) according to claim 1, characterized in that said transmitter (4) is enclosed in a shock-resistant case (14) with a suitable protection degree, small size, and having externally a serial number (15) of identification of the transmitter contained therein, and provided with a flexible antenna (16) outside the case (14), said case (14) being also provided with hook means (17) for securing a belt, collar, necklace or any other member (18) to make transmitter (4) integral with object (2).

22. The position finding system (1) according to claim 1, characterized in that said transmitter (4) can be manufactured in the shape and the size of an OEM card which can be integrated.

23. The position finding system (1) according to claim 1, characterized in that said transmitters (4) are used as receivers provided with hardware and firmware similar to those of transceivers (3, 3.1) upon regulation of the transmitter's parameters such as frequency of transmission of the signal or still where communications are exchanged not only in position finding mode but also in identification mode so as to be compatible with the worldwide EPC standard of second generation in versions UHF and/or 2.4 GHz or still, if enabled via firmware, to receive beacons or to transmit in a synchronized way.

24. The position finding system (1) according to claim 1, characterized in that transmitters (4) are provided with internal sensors (for detecting atmospheric pressure, temperature, humidity, etc.) to allow the transmission of data detected by the sensors in addition to those relative to its identification and position.

25. The position finding system (1) according to claim 1, characterized in that said transmitters (4) and transceivers (3, 3.1) in transmitting mode use their internal memory to store their positions when they use a GPS module always operated in LOW-POWER mode in association with an internal wireless SRD module, and use in transceiver (3.1) mode the positions of other transmitters (4) in all time intervals in which they were not previously detectable by transceiver (3, 3.1) to transmit them thereafter via radio connection.
